(19) United States
(12) Patent Application Publication
(10) Pub. No.: US 2023/0404080 A1
(43) Pub. Date: Dec. 21, 2023

(54) A METHOD OF CONTROLLING HERBICIDE RESISTANT WEEDS

(71) Applicants: UPL Corporation Limited, Port Louis (MU); UPL Europe Ltd., Cheshire (GB)

(72) Inventors: Diego Henrique Mendes Costa, Campinas (BR); Ferdinando Marcos Lima Silva, Tatui (BR); Flavia Ferreira Megda, Campinas (BR)

(21) Appl. No.: 18/252,503

(22) PCT Filed: Nov. 10, 2021
(86) PCT No.: PCT/GB2021/052902

§ 371 Date: May 10, 2023

(30) Foreign Application Priority Data
Nov. 11, 2020 (GB) 2017789.5A

(51) Int. Cl. A01N 57/20; A01N 43/40; A01N 43/50; A01N 43/653; A01N 43/84; A01N 37/22

(52) U.S. Cl. CPC A01N 57/20; A01N 43/40; A01N 43/50; A01N 43/653; A01N 43/84; A01N 37/22

(57) ABSTRACT

The present invention relates to a method for effectively controlling herbicide resistant weeds such as Spermacoce verticillate. The present invention provides a method of reducing the population Spermacoce verticillate weeds by applying sequentially a herbicide combination to target said weeds.

### FIELD OF INVENTION

The present invention relates to the field of plant protection, particularly, to a method for the effective control of undesired weeds. More particularly, the present invention relates to a method of selectively controlling undesirable vegetation that are resistant to herbicides.

### BACKGROUND OF THE INVENTION

Weeds are undesirable plants that can severely damage yield in crops. Farmers usually control these plants at the pre-plant stage as well as after sowing. Modern herbicides are used to either control or suppress these undesirable plants to allow sown crops a greater share of nutrient.

Protection of planted crops from undesirable plants which inhibit crop growth is a perpetual struggle for all farmers. Herbicides have been used to control growth of such plants. There are many herbicides and combinations known in the art.

Current practices include combining herbicides with varied modes of action, which allows broader spectrum of control and resistance management. However, the combinations currently known are not sufficient to control the resistant and persistent weeds. There is always a need in the art for improved herbicidal combinations with enhanced weed control efficacy.

However, the combination of herbicides may not always result in the desired effect. Combination of herbicides may lead to an additive effect or an antagonistic effect. It may also result in phytotoxicity to the crops making it an undesirable combination. Agronomists must therefore, carefully select the herbicides that can be combined to offer a synergistic effect that would control weeds while having no phytotoxic effect on the crop and reduce the chances of development of herbicide resistant weeds. Herbicide tank-mixtures may be used to prevent the development of herbicide-resistant weeds by attacking weeds at more than one lethal site of action. However, tank-mixtures may also result in unexpected interactions between herbicides, such as antagonism.

Glufosinate ammonium, a glutamine synthetase herbicide (Group 10) is a broad-spectrum post emergent herbicide that controls most annual grasses and broadleaves. It is a contact herbicide with limited translocation throughout the plant. The glutamine synthetase herbicides inhibit activity of glutamine synthetase, the enzyme that converts glutamate and ammonia to glutamine. Glufosinate is an excellent tool for resistance management. It is mainly used for post-emergent control of weeds and grass weeds.

Glycines (glyphosate) are herbicides that inhibit 5-enolpyruvylshikimate-3-phosphate (EPSP) synthase (Group 9), a key enzyme in the shikimic acid pathway, which is involved in the synthesis of aromatic amino acids. Glyphosate [N-(phosphonomethyl)glycine] is a non-selective, broad spectrum, systemic, post-emergence herbicide that has been used extensively throughout the world over the past three decades for weed management. It inhibits the biosynthesis of aromatic amino acids (phenylalanine, tryptophan, and tyrosine), which leads to several metabolic disturbances, including the inhibition of protein and secondary product biosynthesis and the deregulation of the shikimate pathway, leading to general metabolic disruption.

When weeds evolve resistance to herbicides, their management becomes more challenging due to the lack of an alternative mode of action (MOA) available for weed control. However, compositions and methods that are effective in controlling undesirable vegetation need to be maintained.

Intensive glyphosate selection has resulted in the widespread evolution of glyphosate-resistant (GR) weed populations, threatening the sustainability of this valuable once-in-a-century agrochemical. Management of GR weeds is a challenge and widespread occurrence of GR weeds in several states requires alternate weed management programs.

This GR weed species needs to be controlled by more than one herbicide in the program, which can be difficult and challenging with a very limited range of effective herbicide options.

Herbicides have become increasingly important in agriculture and this reliance has resulted in an increase in the number of herbicide-resistant weed populations. A holistic strategy towards managing herbicide-resistant weeds is crucial for agricultural sustainability and rising crop yield rates that will provide food, fibre, and energy to a growing population. Integrated weed management is the combination of multiple weed control methods to reduce weed interference below the economic threshold level. Therefore, when weeds evolve resistance to herbicides, their management becomes more challenging due to the lack of alternative mode of actions available for selective grass control in post-emergence.

There remains a need for improved practices for preventing, delaying or effectively managing the weeds that develop herbicidal resistance thereby improving crop yield and health, with reduced phytotoxicity. Thus, there is also a need to develop herbicide combination strategies that are synergistic and help in herbicide resistance management.

Embodiments of the present invention may therefore ameliorate one or more of the above-mentioned problems:

### SUMMARY OF THE INVENTION

In one aspect, the present invention relates to the field of plant protection, particularly, to a method for the effective control of undesired weeds.

In another aspect the present invention provides herbicidal compositions, which show enhanced herbicide action against undesirable harmful plants and/or have improved compatibility with the useful plants in particular crop plants.

Another aspect of the present invention is to provide effective control of herbicide-resistant weeds, in particular the weeds that are resistant to Group 4 and Group 9 herbicides in agriculture field.

In another aspect the present invention provides a method for controlling the growth of herbicide resistant weeds, which comprises contacting such weeds, parts of it, with a herbicide combination.

In another aspect the method of present invention reduces the population of verticillate weeds in particular Spermacoce verticillate by applying concurrently or subsequently or sequentially a herbicide combination to target weeds.

In another aspect the present invention provides a method for controlling Spermacoce verticillate.

In another aspect the invention provides an effective and quick method for controlling Spermacoce verticillate.

In another aspect, the present invention provides a method of controlling weeds resistant to herbicides wherein said weeds are treated by applying concurrently or subsequently or sequentially a combination comprising herbicides to target weeds.

In another aspect, the present invention provides a method of controlling Spermacoce verticillate weeds wherein said method comprises applying concurrently or subsequently or sequentially a herbicide combination to target weeds.

In another aspect the present invention improves the control method and solves the problems such as the control efficiency being poor and efficient prevention and treatment purpose, better than conventional methods.

In another aspect the present invention provides a method of preventing an increase of adult Spermacoce verticillate population.

In another aspect the present invention provides a method which does not affect the normal growth of crop/plants.

Yet another aspect of the present invention is to provide a method of increasing yield in a crop by application of herbicidal combination.

Another aspect of the present invention is to provide a method of improving the crop health by application of herbicidal combination.

In another aspect the present invention provides a complete strategy towards controlling the growth of herbicide-resistant weeds for agricultural sustainability and rising crop yield rates.

### DESCRIPTION OF PRESENT INVENTION

For the purposes of the following detailed description, it is to be understood that the invention may assume various alternative variations, except where expressly specified to the contrary. Moreover, other than in any operating examples, or where otherwise indicated, all numbers expressing, for example, quantities of materials/ingredients used in the specification are to be understood as being modified in all instances by the term “about”. The term “about” used to qualify the amounts of active components shall be interpreted to mean “approximately” or “reasonably close to” and any statistically insignificant variations therefrom.

As used herein, the terms “comprising” “including,” “having,” “containing,” “involving,” and the like are to be understood to be open-ended, i.e., to mean including but not limited to.

In any aspect or embodiment described hereinbelow, the phrase comprising may be replaced by the phrases “consisting of” or “consisting essentially of” or “consisting substantially of”. In these aspects or embodiment, the combination or composition described includes or comprises or consists of or consists essentially of or consists substantially of the specific components recited therein, to the exclusion of other ingredients or excipients not specifically recited therein.

The term herbicide, as used herein, shall mean an active ingredient that kills, controls or otherwise adversely modifies the growth of undesired plants.

As used herein, a herbicidally effective or vegetation controlling amount is an amount of active ingredient that causes a “herbicidal effect,” i.e., an adversely modifying effect and includes deviations from natural development, killing, regulation, desiccation, retardation.

The terms “plants” and “vegetation” include, but are not limited to, germinant seeds, emerging seedlings, plants emerging from vegetative propagules, and established vegetation.

The terms “undesirable vegetation”, “harmful plants”, “unwanted plants”, “weeds” and “weed species”, as used herein, are synonyms.

The term “locus” as used herein shall denote the vicinity of a desired crop in which weed control, typically selective weed control is desired. The locus includes the vicinity of desired crop plants wherein the weed infestation has either emerged or is yet to emerge.

The term “crop” shall include a multitude of desired crop plants or an individual crop plant growing at a locus.

A used herein, a reference to Group 4 herbicides includes references to synthetic auxins which are chemicals disrupting plant cell growth in newly forming stems and leaves (malformed growth). These herbicides include phenoxy-carboxylic acids (e.g., 2,4-dichlorophenoxyacetic acid); dichlorprop (2,4-DP), methylchlorophenoxypropionic acid, 2-methyl-4-chlorophenoxyacetic acid and the like. benzoic acids (e.g., dicamba); pyridine acids (e.g., picloram, clopyralid); quinoline carboxylic acids (e.g., quinclorac); and pyrimidine carboxylic acid (e.g. aminocyclopyrachlor).

A used herein, a reference to Group 9 herbicides includes references to inhibitors of 5-enolpyruvylshikimate-3-phosphate synthase (EPSP). These chemicals inhibit amino acid synthesis through the shikimate pathway

Each of the aspect described above may have one or more embodiments.

Each of the embodiments described hereinafter may apply to one or all the aspects described hereinabove. These embodiments are intended to be read as being preferred features of one or all the aspects described hereinabove. Each of the embodiments described hereinafter applies to each of the aspects described hereinabove individually.

Weed resistance or tolerance to herbicides has been increasing in Brazil and around the world, and new ways of using the available products is essential to manage this problem. Spermacoce verticillate (S. verticillate) has been reported as one of the important weeds in annual and perennial crops in the North and Midwest of Brazil, largely due to their tolerance to 2,4-D synthetic auxin herbicides and glyphosate that are the main herbicides used at broadleaves burndown. Therefore, the control becomes insufficient with a single application of these herbicides alone or in mixtures such as with glyphosate and 2,4-D.

Some herbicides are efficient for controlling Spermacoce verticillate, but this efficiency is restricted only to the early stages of development (4 to 6 leaves), adult plants with more than 6 leaves showing side shoots and in the flowering stage are not satisfactorily controlled even after single or sequential applications of herbicides. Farmers have been facing this problem and have no alternative methods to control this weed (S. verticillate) when it reaches the later stages of development, as S. verticillata is relatively resistant to many of the most common herbicides including 2,4-D, MCPA, atrazine and metolachlor. The present invention is aimed to solve this problem.

Surprisingly, it has been found by the present inventors that a sequential application of a combination of glufosinate and/or one or more herbicides after an application of glyphosate and/or one or more herbicides is used to effectively control S. verticillate, a weed which grows in main agricultural areas and that is tolerant/resistant to main herbicides used for burndown, for example glyphosate, 2,4-D and other auxin herbicides.

The present method results in an effective control of herbicide resistant weeds at the locus of the desirable crop plants when the combination of herbicides is applied in a sequential manner. The resulting phytotoxicity usually seen with application of glyphosate and glufosinate or combinations thereof for controlling weeds is also absent when these herbicides are applied in a sequential manner.

According to the present invention, there is provided an effective and quick method to control S. verticillate weeds. The method comprises applying herbicides in a sequential application which efficiently controls this weed.

In an embodiment, the present invention provides preferred combinations, compositions and methods thereof. The methods of the invention include a method of controlling weeds at a locus by applying to the locus the combination or the composition, or a method of increasing yield in a crop by application of the combination or composition, or a method of improving the plant health by application at the locus of the plant the combination or the composition. The embodiments described herein describe the preferred embodiments of all these possible combinations, compositions and methods of the invention.

In an aspect the present invention relates to herbicidal combinations. The invention also relates to methods and uses for controlling undesirable vegetation, particularly in crop fields.

In another aspect the present invention provides an effective control of herbicide-resistant weeds, wherein the herbicide resistant weeds are resistant to at least one herbicide belonging to Group 9 and Group 4.

Typically, the target weeds of present invention are tolerant to glyphosate, auxin herbicides and the like.

The present invention provides a method for controlling herbicide resistant weeds, particularly, Spermacoce verticillate.

In a preferred embodiment the herbicide tolerant weed is Spermacoce verticillate.

In another aspect, the invention provides a highly effective and quick method for controlling Spermacoce verticillate that is tolerant to herbicides belonging to Group 9 and Group 4.

In another aspect, the invention provides a highly effective and quick method for controlling Spermacoce verticillate that is tolerant to glyphosate (Group 9) and auxin herbicides (Group 4) such as phenoxy-carboxylic acids (e.g., 2,4-dichlorophenoxyacetic acid); benzoic acids (e.g., dicamba); pyridine acids (e.g., picloram, clopyralid); quinoline carboxylic acids (e.g., quinclorac); and pyrimidine carboxylic acid (e.g. aminocyclopyrachlor).

In an embodiment, the present invention provides a method of controlling herbicide resistant weeds by applying sequentially to a locus a combination of herbicides comprising
(i) a first application comprising a combination of glyphosate and/or one or more herbicides, and
(ii) a second application comprising a combination of glufosinate and/or one or more herbicides.

The present invention provides that an application of glyphosate and/or one or more herbicides at a locus of a crop, followed by an application of glufosinate and/or one or more herbicides at a locus of the said crop, provides for an excellent control of Spermacoce verticillate weeds.

In an embodiment, the preferred glufosinate herbicide is L-glufosinate.

Accordingly, the present inventors have surprisingly found that an application of a combination of herbicides particularly, an application of glyphosate and triclopyr, followed by an application of glufosinate or mixtures of glufosinate provides for an excellent control of S. verticillate weed.

In an aspect, the weeds are resistant to herbicides selected from the group comprising 5-enolpyruvylshikimate-3-phosphate synthase inhibiting herbicides and growth regulating herbicides.

In an embodiment, the weeds are resistant to a 5-enolpyruvylshikimate-3-phosphate synthase inhibiting herbicide, glyphosate.

In another embodiment, the Spermacoce verticillate weeds are resistant to growth regulating herbicides selected from the group comprising auxin herbicides (Group 4) such as phenoxy-carboxylic acids (e.g., 2,4-dichlorophenoxyacetic acid); benzoic acids (e.g., dicamba); pyridine acids (e.g., picloram, clopyralid); quinoline carboxylic acids (e.g., quinclorac); and pyrimidine carboxylic acid (e.g. aminocyclopyrachlor).

In an embodiment, the first application comprises a combination of glyphosate and one or more herbicides selected from glyphosate and one or more herbicides of growth regulating herbicides.

In an embodiment, the first application comprises a combination of glyphosate and triclopyr.

In an embodiment the herbicide applied sequentially is glufosinate or its salts.

In an embodiment, the herbicide applied sequentially is L-glufosinate or its salts.

Preferably, the herbicide sequentially applied comprises L-glufosinate in its free form or in salt form, in particular potassium, sodium, ammonium, trimethylsulfonium, monoethanol ammonium, isopropylammonium, triazolamine salt or any other agrochemically acceptable salt. Preferably, glufosinate ammonium is used as selective herbicide.

In an embodiment, the preferred glufosinate herbicide applied sequentially is L-glufosinate or L-glufosinate ammonium and/or one or more herbicides.

In another aspect, the present invention provides a method of controlling weeds resistant to herbicides wherein said weeds are treated by applying concurrently or sequentially, herbicidally effective amounts of at least two herbicides to target weeds.

In another aspect, the present invention provides a method of controlling weeds resistant to herbicides, wherein said weeds are controlled by applying to a locus of crops, concurrently or sequentially, a composition comprising a herbicidally effective amount of a combination of herbicides.

In an embodiment, the present invention provides a method of controlling weeds resistant to herbicides belonging to Group 4 and Group 9, the method comprising applying glyphosate and/or one or more herbicides at a locus of a crop with a sequential application of glufosinate and/or one or more herbicides to effectively control herbicide resistant Spermacoce verticillate weeds.

Preferably, the method comprises applying glyphosate and triclopyr with a sequential application of L-glufosinate or glufosinate and one or more herbicides to effectively control herbicide resistant weed, which is Spermacoce verticillate.

In an embodiment, the second application comprises a combination of L-glufosinate or its salts and one or more herbicides selected from the group comprising flumioxazin, imazethapyr, metolachlor and carfentrazone.

In one preferred embodiment, the second application comprises a combination of L-glufosinate ammonium and one or more herbicides selected from the group comprising flumioxazin, imazethapyr, metolachlor and carfentrazone.

In an embodiment the method of present invention significantly controls the herbicide resistant weeds within a period of 10 to 30 days.

In an embodiment the method comprises applying a herbicidally effective amount of the combination of herbicides within a period of 10 to 30 days.

In an embodiment the method comprises applying a herbicidally effective amount of the combination of herbicides concurrently or sequentially within a period of 10 to 30 days, preferably within a period of 10 to 15 days.

According to the method of the present invention adult plants of Spermacoce verticillate that are resistant to herbicides, particularly herbicides of Group 4 and Group 9 is controlled with the application of glyphosate and triclopyr followed by an application of glufosinate after 10 to 30 days of the first application, preferably within a period of 10 to 15 days.

According to the method of the present invention adult plants of Spermacoce verticillate that are resistant to herbicides, particularly herbicides of Group 4 and Group 9 is controlled with the application of glyphosate and triclopyr followed by an application of L-glufosinate or its salts after 10 to 30 days of the first application, preferably within a period of 10 to 15 days.

According to the method of the present invention, adult plants of Spermacoce verticillate that are resistant to herbicides, particularly herbicides of Group 4 and Group 9 are controlled with an application of glyphosate and triclopyr followed by an application of a combination of herbicides selected from one or more of glufosinate and flumioxazin after 10 to 30 days, preferably within a period of 10 to 15 days.

According to the method of the present invention, adult plants of Spermacoce verticillate that are resistant to herbicides, particularly herbicides of Group 4 and Group 9 are controlled with an application of glyphosate and triclopyr followed by an application of a combination of herbicides selected from one or more of L-glufosinate or its salts and flumioxazin after 10 to 30 days, preferably within a period of 10 to 15 days.

According to the method of the present invention, adult plants of Spermacoce verticillate that are resistant to herbicides, particularly herbicides of Group 4 and Group 9 are controlled with an application of glyphosate and triclopyr followed by an application of a combination of herbicides selected from one or more of glufosinate and metolachlor after 10 to 30 days, preferably within a period of 10 to 15 days.

According to the method of the present invention, adult plants of Spermacoce verticillate that are resistant to herbicides, particularly herbicides of Group 4 and Group 9 are controlled with an application of glyphosate and triclopyr followed by an application of a combination of herbicides selected from one or more of L-glufosinate or its salts and metolachlor after 10 to 30 days, preferably within a period of 10 to 15 days.

According to the method of the present invention, adult plants of Spermacoce verticillate that is resistant to herbicide is controlled with the application of glyphosate and triclopyr followed by application of a combination of herbicides selected from glufosinate, imazethapyr and carfentrazone after 10 to 30 days, preferably within a period of 10 to 15 days.

According to the method of the present invention, adult plants of Spermacoce verticillate that is resistant to herbicide is controlled with the application of glyphosate and triclopyr followed by application of a combination of herbicides selected from L-glufosinate or its salts, imazethapyr and carfentrazone after 10 to 30 days, preferably within a period of 10 to 15 days.

According to the method of the present invention adult plants of Spermacoce verticillate that is resistant to herbicide is controlled with the application of glyphosate and triclopyr followed by application of herbicides selected from glufosinate and carfentrazone after 10 to 30 days, preferably within a period of 10 to 15 days.

According to the method of the present invention adult plants of Spermacoce verticillate that is resistant to herbicide is controlled with the application of glyphosate and triclopyr followed by application of herbicides selected from L-glufosinate or its salts and carfentrazone after 10 to 30 days, preferably within a period of 10 to 15 days.

According to the method of the present invention adult plants of Spermacoce verticillate that is resistant to herbicide is controlled with the application of glyphosate and triclopyr followed by an application of herbicides selected from glufosinate and imazethapyr after 10 to 30 days, preferably within a period of 10 to 15 days.

According to the method of the present invention adult plants of Spermacoce verticillate that is resistant to herbicide is controlled with the application of glyphosate and triclopyr followed by an application of herbicides selected from L-glufosinate or its salts and imazethapyr after 10 to 30 days, preferably within a period of 10 to 15 days.

The combination may be applied to the locus of the weeds in herbicidally effective amounts. The selection of the appropriate effective amounts depends on the density of weed infestation, weather patterns, crop health and many other factors.

In an embodiment, glufosinate or glyphosate or their salts may be used in an amount of from about 1 g/ha to about 5000 g/ha.

In an embodiment, glufosinate or its salts may be used in an amount from about 5 g/ha to about 800 g/ha.

In an embodiment, glufosinate or its salts may be used in an amount about 100 g/ha to 400 g/ha.

In an embodiment, L-glufosinate or its salts may be used in an amount from about 5 g/ha to about 800 g/ha.

In an embodiment, the concentration of one or more herbicides of the second application is ranging from 10 to 1200 g/ha.

In an embodiment, the concentration of one or more herbicides of the first application is ranging from 500 to 1500 g/ha.

In an embodiment, the herbicides of the present invention may be applied with at least one other active ingredient selected from the group consisting of herbicides, insecticides, fungicides, biological agents, plant growth activators, fertilizers or combinations thereof.

The compositions may further comprise at least one agrochemically acceptable excipient.

The dosage level of the individual herbicides may be defined by the inherent efficacy of the compound, the pest pressure, soil type, the weather, the formulation type and many other indeterminate variables. These standard dosage levels are fixed by the regulatory authorities.

These compositions can be applied by spraying onto the weeds to be treated. The application dose will of course depend on the nature of the crop and the weed to be treated. For example, these herbicide combinations, compositions can be applied at a rate of 0.1 to 10 L/ha, preferably from 0.5 to 8 L/ha, and even more preferably from 1 to 5 L/ha, typically 1 L/ha to 3 L/ha of crop to be treated.

In an embodiment, the individual components of the combination of the present invention may be applied to the locus either simultaneously or sequentially, such that glyphosate and mixture as well as glufosinate and mixture as mentioned herein above may be applied in a tank mix or as a pre-mixed composition within a period of 10 to 30 days of each other.

The herbicidal compositions of the present disclosure can be in any conventional agriculturally useful form, for example, in the form of a ready-to-use formulation, or in the form of a tank mix.

In an embodiment, the herbicidal compositions of the present disclosure are tank mixes.

In an embodiment, combination of the present invention may be applied either pre or post emergent. The advantage of the combination is surprisingly good residual effects, when applied in post-emergent leading to quick control of weeds.

In an embodiment, the composition of the present invention may contain agriculturally acceptable adjuvants, carriers, diluents, emulsifiers, fillers, antifoaming agents, thickening agents, anti-freezing agents, freezing agents etc. The compositions may be either solid or liquids. They can be solids, such as, for example, dusts, granules, water-dispersible granules, microcapsules or wettable powders, or liquids, such as, for example, emulsifiable concentrates, solutions, emulsions or suspensions, ZC formulations. They can also be provided as a pre-mix or tank mixes.

Suitable agricultural adjuvants and carriers may include, but are not limited to, crop oil concentrates; methylated seed oils, emulsified methylated seed oil, nonylphenol ethoxylate; benzylcocoalkyldimethyl quaternary ammonium salt; blend of petroleum hydrocarbon, alkyl esters, organic acid, and anionic surfactant; C₉-C₁₁ alkylpolyglycoside; phosphated alcohol ethoxylate; natural primary alcohol (C₁₂-C₁₆) ethoxylate; di-sec-butylphenol EO-PO block copolymer; polysiloxane-methyl cap; nonylphenol ethoxylate, urea ammonium nitrate; tridecyl alcohol (synthetic) ethoxylate (8EO); tallow amine ethoxylate; PEG(400) dioleate-99, alkyl sulfates, such as diethanolammonium lauryl sulfate; alkylarylsulfonate salts, such as calcium dodecylbenzenesulfonate; alkylphenol-alkylene oxide addition products, such as nonylphenol-C₁₈ ethoxylate; alcohol-alkylene oxide addition products, such as tridecyl alcohol-C₁₆ ethoxylate; soaps, such as sodium stearate; alkyl-naphthalene-sulfonate salts, such as sodium dibutylnaphthalenesulfonate; dialkyl esters of sulfosuccinate salts, such as sodium di(2-ethylhexyl)sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; vegetable or seed oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils, and in certain embodiments, methyl esters.

Suitable liquid carriers that may be employed in a composition of the present invention may include water or organic solvents. The organic solvents include, but are not limited to, petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like. Organic solvents include, but are not limited to toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide.

Solid carriers that may be employed in the compositions of the present invention may include but are not limited to attapulgite, pyrophyllite clay, silica, kaolin clay, kieselguhr, chalk, diatomaceous earth, lime, calcium carbonate, bentonite clay, Fuller's earth, talc, cottonseed hulls, wheat flour, soybean flour, pumice, wood flour, walnut shell flour, lignin, cellulose etc.

Other exemplary additives which can be used in the compositions provided herein include, but not limited to, at least one compatibilizers, antifoaming agents, sequestering agents, neutralizing agents and buffers, corrosion inhibitors, coloring agents, odorants, spreading agents, permeation aids, fixing agents, dispersants, thickeners, freezing point depressants, anti-microbial agents etc.

In another aspect, method may further comprise applying at least one adjuvant or at least one safener.

In accordance with present invention the method of control of target weeds may be carried out by spraying the suggested tank mixes, or the individual herbicides may be formulated as a kit-of-parts containing various components that may be mixed as instructed prior to spraying.

The herbicidal combinations of the present invention maybe used to target weeds selected from the group comprising Echinochloa crus-galli, Setaria viridis, Setaria faberi, Setaria glauca, Setaria geniculata, Digitaria ciliaris, Digitaria sanguinalis, Digitaria horizontalis, Digitaria insularis, Eleusine indica, Poa annua, Alospecurus aequalis, Alopecurus myosuroides, Avena fatua, Sorghum halepense, Sorghum vulgare, Agropyron repens, Lolium multiflorum, Lolium perenne, Lolium rigidum, Bromus secalinus, Bromus tectorum, Hordeum jubatum, Aegilops cylindrica, Phalaris arundinacea, Phalaris minor, Apera spica-venti, Panicum dichotomiflorum, Panicum texanum, Panicum maximum, Brachiaria platyphylla, Brachiaria ruziziensis, Brachiaria plantaginea, Brachiaria decumbens, Brachiaria brizantha, Brachiaria humidicola, Cenchrus echinatus, Cenchrus pauciflorus, Eriochloa villosa, Pennisetum setosum, Chloris gayana, Eragrostis pilosa, Rhynchelitrum repens, Dactyloctenium aegyptium, Ischaemum rugosum, Oryza sativa, Paspalum notatum, Paspalum maritimum, Pennisetum clandestinum, Pennisetum setosum or Rottboellia cochinchinensis.

The herbicidal combinations of the present invention maybe used to target weeds among the crops such as corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., vines, kaki fruit, olive, plum, banana, oil palm, coffee, date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

The target weeds are selected from family of Spermacoce weeds.

Preferably the target weed is Spermacoce verticillate.

The method of controlling Spermacoce verticillate weeds according to the present invention wherein said method comprises applying concurrently or subsequently or sequentially herbicide combinations to target weeds.

In an embodiment, the adult plants of Spermacoce verticillate which is resistant to herbicides like glyphosate and auxin herbicide like 2,4 D, can be effectively controlled by sequential application of glyphosate and at least 7 days, typically about 10 to 15 days later application of L-glufosinate or its salts and/or one or more herbicides with at least one other herbicide to target herbicide resistant weeds.

In an embodiment, the adult plants of Spermacoce verticillate which is resistant to herbicides like glyphosate and growth regulating herbicide like 2,4 D, can be effectively controlled by sequential application of glyphosate and at least 7 days, typically about 10 to 15 days later application of L-glufosinate or its salts and/or one or more herbicides with at least one other herbicide to target herbicide resistant weeds.

Therefore, in an embodiment, the present invention provides a method of controlling weeds at a locus, the method comprising:
(a) applying glyphosate and triclopyr at the target locus; and
(b) within about 10 to about 15 days, applying glufosinate to the locus.

In another embodiment, the present invention provides a method of controlling weeds at a locus, the method comprising:
(a) applying glyphosate and triclopyr at the target locus; and
(b) within about 10 to about 15 days, applying combination of glufosinate with another herbicide to the locus.

In another embodiment, the present invention provides a method of controlling weeds at a locus, the method comprising:
(a) applying glyphosate and triclopyr to the locus; and
(b) applying glufosinate to the locus, wherein glufosinate is applied at least 7 days after the application of glyphosate and triclopyr.

In another embodiment, the present invention provides a method of controlling weeds at a locus, the method comprising:
(a) applying glyphosate and triclopyr to the locus; and
(b) applying glufosinate to the locus, wherein glufosinate is applied at least 14 days after the application of glyphosate and triclopyr.

In another embodiment, the present invention provides a method of controlling weeds at a locus, the method comprising:
(a) applying glyphosate and triclopyr to the locus; and
(b) applying glufosinate to the locus, wherein glufosinate is applied at least 21 days after the application of glyphosate and triclopyr.

In another embodiment, the present invention provides a method of controlling weeds at a locus, the method comprising:
(a) applying glyphosate and triclopyr to the locus; and
(b) applying glufosinate to the locus, wherein glufosinate is applied at least 28 days after the application of glyphosate and triclopyr.

In another embodiment, the present invention provides a method of controlling weeds at a locus, the method comprising:
(a) applying glyphosate and triclopyr to the locus; and
(b) applying L-glufosinate to the locus, wherein L-glufosinate is applied at least 7 days after the application of glyphosate and triclopyr.

In another embodiment, the present invention provides a method of controlling weeds at a locus, the method comprising:
(a) applying glyphosate and triclopyr to the locus; and
(b) applying glufosinate and flumioxazin to the locus, wherein glufosinate and flumioxazin is applied at least 7 days after the application of glyphosate and triclopyr.

In another embodiment, the present invention provides a method of controlling weeds at a locus, the method comprising:
(a) applying glyphosate and triclopyr to the locus; and
(b) applying glufosinate and flumioxazin to the locus, wherein glufosinate and flumioxazin is applied at least 14 days after the application of glyphosate and triclopyr.

In another embodiment, the present invention provides a method of controlling weeds at a locus, the method comprising:
(a) applying glyphosate and triclopyr to the locus; and
(b) applying glufosinate and flumioxazin to the locus, wherein glufosinate and flumioxazin is applied at least 21 days after the application of glyphosate and triclopyr.

In another embodiment, the present invention provides a method of controlling weeds at a locus, the method comprising:
(a) applying glyphosate and triclopyr to the locus; and
(b) applying glufosinate and flumioxazin to the locus, wherein glufosinate and flumioxazin is applied at least 28 days after the application of glyphosate and triclopyr.

In another embodiment, the present invention provides a method of controlling weeds at a locus, the method comprising:
(a) applying glyphosate and triclopyr to the locus; and
(b) applying L-glufosinate and flumioxazin to the locus, wherein L-glufosinate and flumioxazin is applied at least 7 days after the application of glyphosate and triclopyr.

In another embodiment, the present invention provides a method of controlling weeds at a locus, the method comprising:
(a) applying glyphosate and triclopyr to the locus; and
(b) applying glufosinate and metolachlor to the locus, wherein glufosinate and metolachlor is applied at least 7 days after the application of glyphosate and triclopyr.

In another embodiment, the present invention provides a method of controlling weeds at a locus, the method comprising:
(a) applying glyphosate and triclopyr to the locus; and
(b) applying glufosinate and metolachlor to the locus, wherein glufosinate and metolachlor is applied at least 14 days after the application of glyphosate and triclopyr.

In another embodiment, the present invention provides a method of controlling weeds at a locus, the method comprising:
(a) applying glyphosate and triclopyr to the locus; and
(b) applying glufosinate and metolachlor to the locus, wherein glufosinate and metolachlor is applied at least 21 days after the application of glyphosate and triclopyr.

In another embodiment, the present invention provides a method of controlling weeds at a locus, the method comprising:
(a) applying glyphosate and triclopyr to the locus; and
(b) applying glufosinate and metolachlor to the locus, wherein glufosinate and metolachlor is applied at least 28 days after the application of glyphosate and triclopyr.

In another embodiment, the present invention provides a method of controlling weeds at a locus, the method comprising:
(a) applying glyphosate and triclopyr to the locus; and
(b) applying L-glufosinate and metolachlor to the locus, wherein L-glufosinate and metolachlor is applied at least 7 days after the application of glyphosate and triclopyr.

In another embodiment, the present invention provides a method of controlling weeds at a locus, the method comprising:
(a) applying glyphosate and triclopyr to the locus; and
(b) applying combination of glufosinate, imazethapyr and carfentrazone to the locus, wherein glufosinate, imazethapyr and carfentrazone is applied at least 7 days after the application of glyphosate and triclopyr.

In another embodiment, the present invention provides a method of controlling weeds at a locus, the method comprising:
(a) applying glyphosate and triclopyr to the locus; and
(b) applying combination of glufosinate, imazethapyr and carfentrazone to the locus, wherein glufosinate, imazethapyr and carfentrazone is applied at least 14 days after the application of glyphosate and triclopyr.

In another embodiment, the present invention provides a method of controlling weeds at a locus, the method comprising:
(a) applying glyphosate and triclopyr to the locus; and
(b) applying a combination of glufosinate, imazethapyr and carfentrazone to the locus, wherein glufosinate, imazethapyr and carfentrazone is applied at least 21 days after the application of glyphosate and triclopyr.

In another embodiment, the present invention provides a method of controlling weeds at a locus, the method comprising:
(a) applying glyphosate and triclopyr to the locus; and
(b) applying a combination of glufosinate, imazethapyr and carfentrazone to the locus, wherein glufosinate, imazethapyr and carfentrazone is applied at least 28 days after the application of glyphosate and triclopyr.

In another embodiment, the present invention provides a method of controlling weeds at a locus, the method comprising:
(a) applying glyphosate and triclopyr to the locus; and
(b) applying combination of L-glufosinate, imazethapyr and carfentrazone to the locus, wherein L-glufosinate, imazethapyr and carfentrazone is applied at least 7 days after the application of glyphosate and triclopyr.

In another embodiment, the present invention provides a method of controlling weeds at a locus, the method comprising:
(a) applying a combination comprising glyphosate and triclopyr to the locus; and
(b) applying a combination comprising glufosinate and carfentrazone to the locus, wherein glufosinate and carfentrazone is applied at least 7 days after the first application.

In another embodiment, the present invention provides a method of controlling weeds at a locus, the method comprising:
(a) applying a combination comprising glyphosate and triclopyr to the locus; and
(b) applying a combination comprising glufosinate and carfentrazone to the locus, wherein glufosinate and carfentrazone is applied at least 14 days after the first application.

In another embodiment, the present invention provides a method of controlling weeds at a locus, the method comprising:
(a) applying a combination comprising glyphosate and triclopyr to the locus; and
(b) applying a combination comprising glufosinate and carfentrazone to the locus, wherein glufosinate and carfentrazone is applied at least 21 days after the first application.

In another embodiment, the present invention provides a method of controlling weeds at a locus, the method comprising:
(a) applying a combination comprising glyphosate and triclopyr to the locus; and
(b) applying a combination comprising glufosinate and carfentrazone to the locus, wherein glufosinate and carfentrazone is applied at least 28 days after the first application.

In another embodiment, the present invention provides a method of controlling weeds at a locus, the method comprising:
(a) applying a combination comprising glyphosate and triclopyr to the locus; and
(b) applying a combination comprising L-glufosinate and carfentrazone to the locus, wherein L-glufosinate and carfentrazone is applied at least 7 days after the first application.

In another embodiment, the present invention provides a method of controlling weeds at a locus, the method comprising:
(a) applying a combination comprising glyphosate and triclopyr to the locus; and
(b) applying a combination comprising glufosinate and imazethapyr to the locus, wherein glufosinate and imazethapyr is applied at least 7 days after the first application.

In another embodiment, the present invention provides a method of controlling weeds at a locus, the method comprising:
(a) applying a combination comprising glyphosate and triclopyr to the locus; and
(b) applying a combination comprising glufosinate and imazethapyr to the locus, wherein glufosinate and imazethapyr is applied at least 14 days after the first application.

In another embodiment, the present invention provides a method of controlling weeds at a locus, the method comprising:
(a) applying a combination comprising glyphosate and triclopyr to the locus; and
(b) applying a combination comprising glufosinate and imazethapyr to the locus, wherein glufosinate and imazethapyr is applied at least 21 days after the first application.

In another embodiment, the present invention provides a method of controlling weeds at a locus, the method comprising:
(a) applying a combination comprising glyphosate and triclopyr to the locus; and
(b) applying a combination comprising glufosinate and imazethapyr to the locus, wherein glufosinate and imazethapyr is applied at least 28 days after the first application.

In another embodiment, the present invention provides a method of controlling weeds at a locus, the method comprising:
(a) applying a combination comprising glyphosate and triclopyr to the locus; and
(b) applying a combination comprising L-glufosinate and imazethapyr to the locus, wherein L-glufosinate and imazethapyr is applied at least 7 days after the first application.

In an embodiment, the glyphosate herbicide is applied at a rate of about 3 L/ha along with triclopyr at a rate of 1.5 L/ha.

Generally single application of glyphosate herbicide at a rate of about 3 L/ha along with triclopyr at a rate of 1.5 L/ha provides less than 60% control of target weed.

In an embodiment, application of glyphosate herbicide at a rate of about 3 L/ha along with triclopyr at a rate of 1.5 L/ha and sequential application of glufosinate and glufosinate combinations provides more than 60% control of target weed. Typically, the present method of sequential application provides 70% control or 75% control or 80% control or 85% control or 90% control or 95% control of weed.

In an embodiment, the glyphosate herbicide is applied at about 3 L/ha along with triclopyr at a rate of 1.5 L/ha followed by an application of glufosinate at a rate of about 2 L/ha.

In an embodiment, the glyphosate herbicide is applied at about 3 L/ha along with triclopyr at a rate of 1.5 L/ha followed by an application of L-glufosinate at a rate of about 2 L/ha.

In an embodiment, the glyphosate herbicide is applied at about 3 L/ha along with triclopyr at a rate of 1.5 L/ha followed by an application of glufosinate and flumioxazin at a rate of about 1 L/ha.

In an embodiment, the glyphosate herbicide is applied at about 3 L/ha along with triclopyr at a rate of 1.5 L/ha followed by an application of L-glufosinate and flumioxazin at a rate of about 1 L/ha.

In an embodiment, the glyphosate herbicide is applied at a rate of about 3 L/ha along with triclopyr at 1.5 L/ha followed by an application of glufosinate, imazethapyr and carfentrazone at a rate of about 1.25 L/ha.

In an embodiment, the glyphosate herbicide is applied at a rate of about 3 L/ha along with triclopyr at 1.5 L/ha followed by an application of L-glufosinate, imazethapyr and carfentrazone at a rate of about 1.25 L/ha.

In an embodiment, the glyphosate herbicide is applied at about 3 L/ha along with triclopyr at a rate of 1.5 L/ha followed by an application of glufosinate and imazethapyr at a rate of about 1 L/ha.

In an embodiment, the glyphosate herbicide is applied at about 3 L/ha along with triclopyr at a rate of 1.5 L/ha followed by an application of L-glufosinate and imazethapyr at a rate of about 1 L/ha.

In an embodiment, the glyphosate herbicide is applied at about 3 L/ha along with triclopyr at a rate of 1.5 L/ha followed by an application of glufosinate and carfentrazone at a rate of about 1 L/ha.

In an embodiment, the glyphosate herbicide is applied at about 3 L/ha along with triclopyr at a rate of 1.5 L/ha followed by an application of L-glufosinate and carfentrazone at a rate of about 1 L/ha.

In another aspect the present invention provides a method of controlling herbicide resistant weeds such that, the method can be applied at pre or post emergence of weeds, thereby providing resistance management and complete control of the weeds.

The present invention thus provides a method for management of Spermacoce verticillate resistant to glyphosate and auxin herbicides, said method comprising sequentially applying the combinations of herbicides.

The present method can be used to control other tolerant or resistant weeds to glyphosate and 2,4-D, such as Conyza spp., Ipomeas spp, Spermacoce latifolia.

In another aspect the method of present invention provides effective controlling in herbicide resistant weeds such that, the method can be applied at pre or post emergence of weeds, thereby providing resistance management and complete control of the weeds.

In an aspect, the compositions of the present invention may be presented in the form of a multi-pack herbicidal product or as a kit-of-parts for treatment of targeted weeds.

In an embodiment, the present invention provides a kit-of-parts comprising a first component of a combination of glyphosate and triclopyr, and a second component of a combination of glufosinate and/or one or more herbicides selected from flumioxazin, imazethapyr, metolachlor and carfentrazone.

The kit-of-parts effectively controls herbicide resistant Spermacoce verticillate weeds.

The present invention therefore provides a method of controlling weeds thereby providing resistance management and synergistic control of the weeds. The present invention also provides an adequate method to achieve complete control of weeds, improving yields, while targeting resistance management.

The invention will now be described in more details with reference to the following examples. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and following examples, but by all embodiments and methods within the scope and spirit of the invention.

### EXAMPLES

Trial Data for Evaluating Management of Spermacoce verticillate Weed

### Example 1

Trials were carried out for evaluating the effect of herbicidal combinations on target weeds of Spermacoce verticillate resistant to herbicides belonging to Group 4 and Group 9. The evaluation for the damage on undesired weeds caused by the present compositions was carried out using a scale from 0 to 100%, compared to the untreated control plants. Here, 0 means no damage and 100 means complete destruction of weed. In the following experiments, the herbicidal activity for the herbicidal combinations was assessed till 28 days after treatment (application A).

In this trial, time T was application time, application A was performed first and at 15 days, application B was performed out in treatments with sequential application. The tested herbicides were sourced from the formulations readily available.

TABLE 1

| | Treatment | | | | | |
|---|---|---|---|---|---|---|
| | | Conc. | | | Conc. | |
| | | active | | | active | |
| | First | ingredient | Rate | Second | ingredient | Rates |
| No. | application (A) | g/ha | kg-L/ha | application (B) | g/ha | kg-L/ha |
| 1. | Control | — | | | | |
| 2. | Glyphosate | 1300 | 3 | — | — | — |
| 3. | Triclopyr | 720 | 1.5 | — | — | — |
| 4. | Glyphosate + | 1940 | 3.0 | — | — | — |
| | Triclopyr (A) | 720 | 1.5 | | | |
| 5. | Glyphosate + | 1940 | 3.0 | Glufosinate | 560 | 2 |
| | Triclopyr (A) | 720 | 1.5 | ammonium (B) | | |
| 6. | Glyphosate + | 1940 | 3.0 | Glufosinate | 500 | 1.25 |
| | Triclopyr (A) | 720 | 1.5 | ammonium + | 50 | |
| | | | | Flumioxazin (B) | | |
| 7. | Glyphosate + | 1940 | 3.0 | Glufosinate | 340 | 1 |
| | Triclopyr (A) | 720 | 1.5 | ammonium + | 85 | |
| | | | | imazethapyr + | 85 | |
| | | | | carfentrazone (B) | | |

The % weed control was observed at 14 days after the sequential application, i.e. 14 DA-B. The results were tabulated as hereunder:

TABLE 2

| Treatment | | | % weed control |
|---|---|---|---|
| No. | Treatment | | at 14 DA-B |
| 1 | Control | — | 0 |
| 2. | Glyphosate (A) | — | 22 |
| 3. | Triclopyr (A) | — | 42.5 |
| 4 | Glyphosate + | — | 60 |
| | Triclopyr (A) | | |
| 5 | Glyphosate + | Glufosinate | 98.5 |
| | Triclopyr (A) | ammonium (B) | |
| 6 | Glyphosate + | Glufosinate | 94 |
| | Triclopyr (A) | ammonium + | |
| | | Flumioxazin (B) | |
| 7 | Glyphosate + | Glufosinate | 92 |
| | Triclopyr (A) | ammonium + | |
| | | imazethapyr + | |
| | | carfentrazone (B) | |

The application of glyphosate and triclopyr, both individually and in combination do not efficiently control S. verticillate weeds. It was observed that S. verticillate was effectively controlled when sequential application of glufosinate, glufosinate+imazethapyr+carfentrazone, glufosinate+flumioxazin was used, after the application of glyphosate+triclopyr at 15 DA-A.

A single application (without a sequential application) the weed control was insufficient (about 60% and was not satisfactory).

Therefore, it was concluded that the present method causes an unexpected synergistic control of resistant Spermacoce verticillate weeds.

### Example 2

Trials were carried out for evaluating the effect of herbicidal combinations on target weeds of Spermacoce verticillate resistant to herbicides belonging to Group 4 and Group 9, specifically, glyphosate and growth regulating herbicides. The evaluation for the damage on undesired weeds caused by the present compositions was carried out using a scale from 0 to 100%, compared to the untreated control plants. Here, 0 means no damage and 100 means complete destruction of weed. In the following experiments, the herbicidal activity for the herbicidal combinations was assessed till 42 days after the first application (A).

In this trial, time T was application time, application A was performed first and 15 days after this, application B was performed out in treatments with sequential application. The tested herbicides were sourced from the formulations readily available.

TABLE 3

| | Treatment | | | | | |
|---|---|---|---|---|---|---|
| | | Conc. | | | Conc. | |
| | | active | | | active | |
| | First | ingredient | Rate | Second | ingredient | Rates |
| No. | application (A) | g/ha | kg-L/ha | application (B) | g/ha | kg-L/ha |
| 1. | Control | — | | | | |
| 2. | Glyphosate + | 1440 | 3.0 | — | — | — |
| | Triclopyr (A) | 720 | 1.5 | | | |
| 3. | Glyphosate + | 1440 | 3.0 | Glufosinate | 560 | 2 |
| | Triclopyr (A) | 720 | 1.5 | ammonium (B) | | |
| 4. | Glyphosate + | 1440 | 3.0 | Glufosinate | 400 | 1 |
| | Triclopyr (A) | 720 | 1.5 | ammonium + | 100 | |
| | | | | imazethapyr + | 10 | |
| | | | | carfentrazone (B) | | |
| 5. | Glyphosate + | 1440 | 3.0 | Glufosinate | 500 | 1.25 |
| | Triclopyr (A) | 720 | 1.5 | ammonium + | 50 | |
| | | | | Flumioxazin (B) | | |
| 6. | Glyphosate + | 1440 | 3.0 | Glufosinate | 448 | 3.5 |
| | Triclopyr (A) | 720 | 1.5 | ammonium + | 1050 | |
| | | | | Metolachlor (B) | | |

The % weed control was observed 42 days after the first application, i.e. 42 DA-A. The results were tabulated as hereunder:

TABLE 4

| Treatment | | | % weed control |
|---|---|---|---|
| No. | Treatment | | at 42 DA-A |
| 1 | Control | — | 0 |
| 2. | Glyphosate + | — | 30 |
| | Triclopyr (A) | | |
| 3 | Glyphosate + | Glufosinate | 71.3 |
| | Triclopyr (A) | ammonium (B) | |
| 4 | Glyphosate + | Glufosinate | 72.5 |
| | Triclopyr (A) | ammonium + | |
| | | imazethapyr + | |
| | | carfentrazone (B) | |
| 5 | Glyphosate + | Glufosinate | 73.8 |
| | Triclopyr (A) | ammonium + | |
| | | Flumioxazin (B) | |
| 6 | Glyphosate + | Glufosinate | 68.8 |
| | Triclopyr (A) | ammonium + | |
| | | Metolachlor (B) | |

It was observed that S. verticillate was effectively controlled when a sequential application of glufosinate, glufosinate+imazethapyr+carfentrazone, glufosinate+flumioxazin and glufosinate+Metolachlor was used, after the application of glyphosate+triclopyr at 15 DA-A.

We claim:

1. A method of controlling herbicide resistant weeds by applying sequentially to a locus a combination of herbicides comprising,
(iii) a first application comprising a combination of glyphosate and/or one or more herbicides, and
(iv) a second application comprising a combination of glufosinate and/or one or more herbicides,
wherein the second application of the combination of herbicides is applied atleast seven days after the first application.

2. The method as claimed in claim 1, wherein the herbicide resistant weed is Spermacoce verticillate.

3. The method as claimed in claim 1, wherein the weeds are resistant to herbicides selected from the group comprising 5-enolpyruvylshikimate-3-phosphate synthase inhibiting herbicides and growth regulating herbicides.

4. The method as claimed in claim 3, wherein the 5-enolpyruvylshikimate-3-phosphate synthase inhibiting herbicide is glyphosate.

5. The method as claimed in claim 3, wherein the growth regulating herbicides are selected from the group comprising dichlorprop (2,4-DP), methylchlorophenoxypropionic acid, 2-methyl-4-chlorophenoxyacetic acid and the like.

6. The method as claimed in claim 1, wherein the first application comprises a herbicide combination comprising glyphosate and triclopyr.

7. The method as claimed in claim 1, wherein glufosinate is applied as a salt selected from the group comprising potassium, sodium, ammonium, trimethylsulfonium, monoethanol ammonium, isopropylammonium, and triazolamine salt.

8. The method as claimed in claim 1, wherein the glufosinate herbicide is L-glufosinate.

9. The method as claimed in claim 8, wherein the glufosinate herbicide is L-glufosinate ammonium.

10. The method as claimed in claim 1, wherein the second application comprises applying a combination of glufosinate and one or more herbicides selected from flumioxazin, imazethapyr, metolachlor and carfentrazone to a locus.

11. The method as claimed in claim 1, wherein the second application is applied at least 14 days after the first application.

12. The method as claimed in claim 1, wherein the second application is applied at least 30 days after the first application.

13. The method as claimed in claim 1, wherein the concentration of one or more herbicides of the first application is ranging from 500 to 1500 g/ha.

14. The method as claimed in claim 1, wherein the concentration of glufosinate is ranging from 200 to 800 g/ha.

15. The method as claimed in claim 1, wherein the concentration of one or more herbicides of the second application is ranging from 10 to 1200 g/ha.

16. The method as claimed in claim 1, wherein the herbicide combinations are applied at a rate of 0.1 to 10 L/ha.

17. The method as claimed in claim 16, wherein the herbicide combinations are applied at a rate of 1 to 5 L/ha.

18. A method of controlling Spermacoce verticillate weeds resistant to herbicides comprising
(i) a first application comprising a combination of glyphosate and/or one or more herbicides, and
(ii) a second application comprising a combination of glufosinate and/or one or more herbicides,
wherein the second application of the combination of herbicides is applied atleast 14 days after the first application.

19. The method of controlling Spermacoce verticillate weeds resistant to herbicides as claimed in claim 18, said method comprising
(i) a first application comprising a combination of glyphosate and triclopyr.
(ii) a second application comprising a combination of glufosinate and/or one or more herbicides selected from flumioxazin, imazethapyr, metolachlor and carfentrazone.
wherein the second application of the combination of herbicides is applied atleast 14 days after the first application.

20. The method of controlling Spermacoce verticillate weeds resistant to herbicides as claimed in claim 18, said method comprising
(i) a first application comprising a combination of glyphosate and triclopyr, and
(ii) a second application comprising glufosinate
wherein the second application of the combination of herbicides is applied atleast 14 days after the first application.

21. The method of controlling Spermacoce verticillate weeds resistant to herbicides as claimed in claim 18, said method comprising
(i) a first application comprising a combination of glyphosate and triclopyr, and
(ii) a second application comprising glufosinate and flumioxazin,
wherein the second application of the combination of herbicides is applied atleast 14 days after the first application.

22. The method of controlling Spermacoce verticillate weeds resistant to herbicides as claimed in claim 18, said method comprising,
(i) a first application comprising a combination of glyphosate and triclopyr, and
(ii) a second application comprising glufosinate and metolachlor,
wherein the second application of the combination of herbicides is applied atleast 14 days after the first application.

23. The method of controlling Spermacoce verticillate weeds resistant to herbicides as claimed in claim 18, said method comprising,
(iii) a first application comprising a combination of glyphosate and triclopyr, and
(iv) a second application comprising glufosinate, imazethapyr and carfentrazone,
wherein the second application of the combination of herbicides is applied atleast 14 days after the first application.

24. A kit-of-parts comprising a first component of a combination of glyphosate and triclopyr, and a second component of a combination of glufosinate or its salts and/or one or more herbicides selected from flumioxazin, imazethapyr, metolachlor and carfentrazone.

25. The kit-of-parts as claimed in claim 24, wherein said kit-of-parts effectively controls herbicide resistant Spermacoce verticillate weeds.
